(19) United States
(12) Patent Application Publication
(10) Pub. No.: US 2007/0265916 A1
(43) Pub. Date: Nov. 15, 2007

(54) System and method for creating loyalty point programs based on print advertisements

(76) Inventors: Roger Robert Belanger, Dover, NH (US); Thomas Bowen Clarke, Durham, NH (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/638,963

(22) Filed: Dec. 14, 2006

Related U.S. Application Data
(63) Continuation-in-part of application No. 11/430,659, filed on May 9, 2006.

(51) Int. Cl. G06Q 30/00

(52) U.S. Cl. 705/14

(57) ABSTRACT

A method for providing individual loyalty point programs for a plurality of print advertisers includes printing first advertising data with a first advertisement by a first print advertiser, the first advertising data identifying the first advertisement, the first advertising data capable of being scanned by a handheld device of a potential customer; and printing second advertising data with a second advertisement by a second print advertiser, the second advertising data identifying the second advertisement, the second advertising data capable of being scanned by the handheld device of the potential customer. The potential customer is provided with a first incentive to scan the first advertising data and a second incentive to scan the second advertising data and the first or second advertising data scanned by the potential customer is received at a central server and as a consequence credits a first or second loyalty point program, respectively, of the potential customer. The first loyalty point program provides loyalty points redeemable at the first print advertiser and the second loyalty point program loyalty points redeemable at the second print advertiser.

### CROSS-REFERENCE TO RELATED APPLICATIONS

This is a continuation-in-part of U.S. Ser. No. 11/430,659, filed May 9, 2006 and hereby incorporated be reference herein.

### BACKGROUND

The present invention relates generally to printed materials with advertising and to handheld devices such as scanners for scanning printed materials.

U.S. Pat. Nos. 6,448,979 and 6,753,883, both hereby incorporated by reference herein, describe printed medium activated interactive communication of multimedia information, including advertising. A scanner and a receiver, which may be a single device, communicate with a portal server to play multimedia sequence information received from the portal server. Advertisements may be printed with a machine readable code such as a barcode including a high density bar code and the data from the code may be read by the scanner. The code contains link information corresponding to provider information and may be an alphanumeric sequence. The sequence may activate and result in the playing of multimedia sequence information. The scanner the receiver or the portal server can translate the link information into a network address, so that the multimedia sequence information can be played. Additionally or in the alternative, the network address information can point to a file containing executable computer code and displayed on the receiver or scanner. The system contemplates using additional code types such as benefit redemption information, rebate information and coupon information. The system may also collect and manage code that lacks link information, such as a UPC code. The person can take the UPC information home and get information on the product, a coupon, or other benefit redemption information.

User input information may be stored in the scanner memory. A communications bridge can send the link information and the user input information to the receiver and via a network to the portal server. The system also is capable of allowing print advertisers to track their impressions to execution and to collect demographic information about the person performing the scan through a tracking module. The tracking module is further capable of tracking the transaction value of e-commerce transactions originating from a specific publication, type of publication, or provider and calculate fee percentages based on the transaction. The scanner may have clock which can track the time the ad was scanned.

U.S. Pat. No. 6,896,182 is also incorporated by reference herein and describes a card verification system in which a card identification code is registered. A read unit reads the card identification code from the card. A verification apparatus verifies the card only when an existing place of the read unit belongs to an area corresponding to the card identification code. The card is a card used for settlement, and is used when the card identification code is read by the read unit. The use place of the card is coincident with the existing place of the read unit. By adding the use place of the card to a verification condition of the card, unjust use of the card can be prevented. This patent also describes a mobile remote operation point-of-sale terminal as disclosed in Japanese Laid Open Patent Application (JP-A-Heisei 11-500550). In an accounting system, a portable radio accounting terminal is provided in which a user inputs transaction data of dealings using keypad, a UPC bar code of the goods is read by a CCD sensor, a credit card, a debit card and a smart card of the user can be read. The portable radio accounting terminal transmits the dealings and card data to a central network controller via a radio communication network. The central network controller transmits to the host computer in the accounting facilities which processes the card data and the dealings in real time in order. The accounting facilities sends back confirmation data to the central network controller and send back to the radio accounting terminal via the radio communication network. Thus, the radio accounting terminal issues the printed receipt of the dealings to the user.

### SUMMARY OF THE INVENTION

The present invention provides a method for providing individual loyalty point programs for a plurality of print advertisers comprising:

printing first advertising data with a first advertisement by a first print advertiser, the first advertising data identifying the first advertisement, the first advertising data capable of being scanned by a handheld device of a potential customer;

printing second advertising data with a second advertisement by a second print advertiser, the second advertising data identifying the second advertisement, the second advertising data capable of being scanned by the handheld device of the potential customer;

providing the potential customer with a first incentive to scan the first advertising data and a second incentive to scan the second advertising data; and

receiving the first or second advertising data scanned by the potential customer at a central server and as a consequence crediting a first or second loyalty point program, respectively, of the potential customer, the first loyalty point program providing loyalty points redeemable at the first print advertiser and the second loyalty point program being redeemable at the second print advertiser.

The present invention also provides a system for providing a centralized plurality of loyalty point programs comprising:

a loyalty point collection server receiving information related to scanned advertising data of a plurality of print advertisers, the loyalty point collection server storing information on a plurality of loyalty point programs for the plurality of print advertisers, and crediting loyalty points to the respective loyalty point programs for individual users of handheld devices as a function of the scanned advertising data.

The present invention also provides a method for providing individual loyalty point programs for a plurality of print advertisers comprising:

providing to a first print advertiser first advertising data to be printed with a first advertisement, the first advertising data identifying the first advertisement, the first advertising data capable of being scanned by a handheld device of a potential customer;

providing to a second print advertiser second advertising data to be printed with a second advertisement, the second advertising data identifying the second advertisement, the second advertising data capable of being scanned by the handheld device of the potential customer;

providing the potential customer with a first incentive to scan the first advertising data and a second incentive to scan the second advertising data; and

receiving the first or second advertising data scanned by the potential customer at a central server and as a consequence crediting a first or second loyalty point program, respectively, of the potential customer, the first loyalty point program providing loyalty points redeemable at the first print advertiser and the second loyalty point program being redeemable at the second print advertiser.

### BRIEF DESCRIPTION OF THE DRAWINGS

The present invention will be described further with respect to the drawings in which:

FIG. 1 shows a schematic of one embodiment of a system of the present invention; and

FIG. 2 shows a flowchart for the creation of loyalty point programs by advertisers.

### DETAILED DESCRIPTION

The present invention advantageously provides that print advertisers can operate and use loyalty point programs based on printed advertisements in a simple and efficient manner. Thus for example, a local print shop could offer to print scannable data with an advertisement, and to offer an incentive to readers who scan the data. The hardware store then can gain information on the advertisement readers, such as the fact that they have read the advertisement. The print shop or a printing press manufacturer for example, or other service provider, can offer to manage the loyalty point programs via a central server. Small retailers who never before had the wherewithal or means to operate loyalty point programs thus can be provided such a service, and also obtain advertising data.

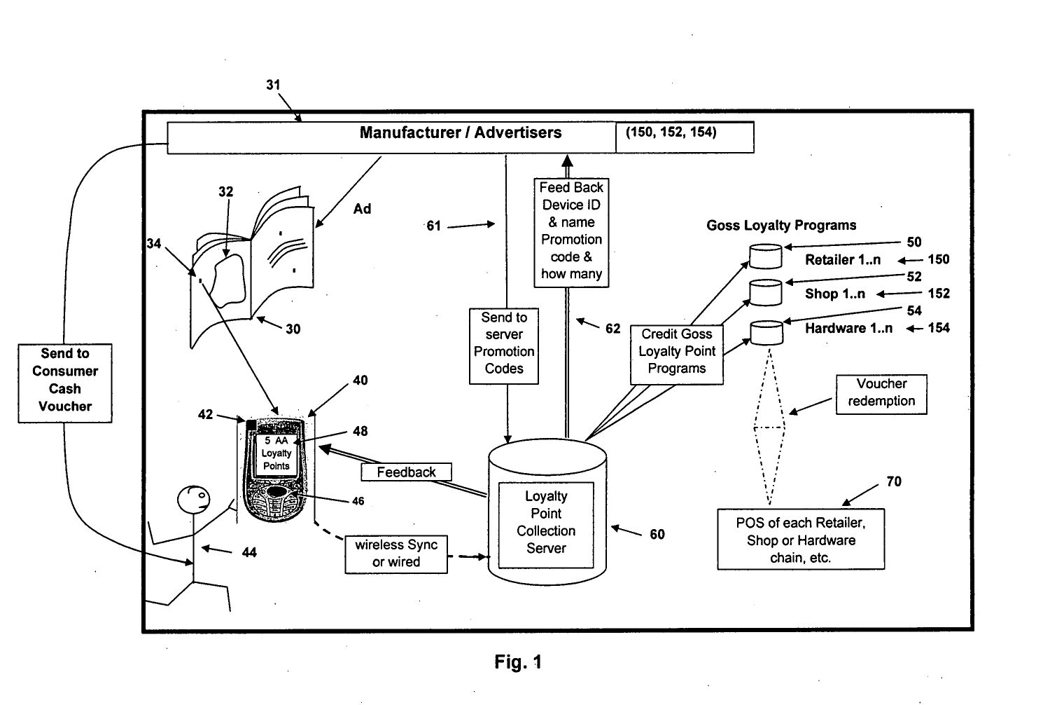

FIG. 1 shows a general overview of one embodiment of the present invention. An advertisement 32 from an advertiser 31 is printed for example in a magazine 30. Advertising data 34, such as the magazine name, page and advertiser identification information can be provided, for example in a code form as described in incorporated by reference U.S. Pat. No. 6,448,979. A potential customer 44 has a handheld device 40 for example an IPOD from Apple, or cell phone, the handheld device having a scanner 42 capable of scanning the printed advertising data 34 and inputting the advertising data into a memory of the handheld device 40. The scanner 42 may be a part of the device or detachable, and may include a camera held still, but preferably scans by movement.

Each scanned advertising data 34 can provide the potential customer 44 with an increase in loyalty points for a specific loyalty points program 70 of the potential customer for the specific print advertiser. For example, the scanned advertisement may be for a local retailer 150 which advertises that the scan will provide an extra 50 points for the retailer's loyalty program. The customer 44 can then link to a home computer or other device, for example via a USB link or infrared link. The customer can then access for example a central server 60 which manages a plurality of loyalty point programs 50, 52, 54 for various advertisers 150, 152, 154. The user may for example mouse click on a window button so that the scanned advertisement data stored on the handheld device related to the local retailer is downloaded to a loyalty point collection server 60 of the airline. The retailer 150 can provide the central server with promotion codes for the advertisements via link 61. When the scanned advertising data is received, the customer's account, via linking with a device ID, can then be credited and the advertising data and promotion code sent to the retailer 150, as shown by link 62. The retailer 150 thus knows that that particular account holder read and scanned a particular advertisement, for example a local magazine advertisement shown on Jun. 6, 2006 on page 5. Information beneficial to the retailer, for example on types of publications a particular loyalty account holder reads and the response rates for advertisements can then be accumulated. This information can be tied into already known data such a purchase patterns of the account holders, and analyzed for improving advertising effectiveness.

In the embodiment described above, a click on the website will start a search of the database of the handheld device for advertising data related to the retailer 150. For example, the advertising data for a particular retailer could start with a unique 5 digit code and any advertising data for that particular retailer is then downloaded to the server 60. The data can then be erased from the handheld device. The loyalty point collection server 60 and/or handheld device 40 may provide duplicative scanning prevention can then ensure that the potential customer does not receive loyalty points for the same add scanned twice.

As opposed to the mouse click embodiment, the advertising data also may be sent to the server 60 from the handheld device 40 so that for example the customer 44 can scroll via an input device 46 on the handheld device 40 through the stored advertising data, for example via display information shown on a display 48. The display information is a function of the advertising data, and additional information may be obtained for example through interface of the handheld device with a server having display information. For example, the name of the retailer may appear for a particular stored advertising data and the customer then can push a button on an input device 46 of the handheld device 40 to send the advertising data to the server 60.

The server 60 can then validate and accept the sent advertising data. In this embodiment, the server can have duplication prevention so that a single ad from one customer can only be accepted once. The user or handheld device can erase the advertising data, since the user knows that the same data will not be accepted again. The sent data may include actual scanned data as well as additional data such as a time when the advertisement was read. The server then can credit the proper loyalty point program, here program 50 of retailer 150, for that user.

Advertisers 31 (including retailer 150, shop owner 152 or hardware store 154) can then determine the effectiveness of the advertisement 32, for example by monitoring scan rates for different publications. The advertiser can also determine the effectiveness of the incentive information associate therewith. For example, the retailer 150 can print 10,000 ads stating that a scan will be worth 10 loyalty points, and 10,000 ads stating that a scan will be worth 20 loyalty points, and provide advertising data indicating which of the ads are worth 10 points and which are worth 20 points. The advertiser can then see if the value change alters the response rate to the ads.

The advertiser 31 also can track redemption of the loyalty points, for example at the point of sale 70.

A printing press manufacturer for magazines or newspapers also could manage the loyalty point collection server 60 and store information on all the advertising data. For example, GOSS INTERNATIONAL CORPORATION could manage the server 60 and provide information to the advertisers 31 and also manage interaction with a plurality of loyalty points programs 50, 52, 54 of the customer 44. The collection server 60 thus, in addition to providing for setting up loyalty point programs for individual advertisers, can also provide a central point for the customer to manage all of the customer's loyalty points programs and require a single password access, and may for example have a single website, such as www.mygossspot.com. When the customer scans the advertisements, and then access the central website and click a mouse, the advertising data from the handheld device would be downloaded and loyalty points for the specific advertisements would be assigned to the loyalty programs 50, 52, 54. Each program account can be viewed on the user's account at the central website, as the advertisers participating in the advertising program are cooperating with the loyalty point collection server manager.

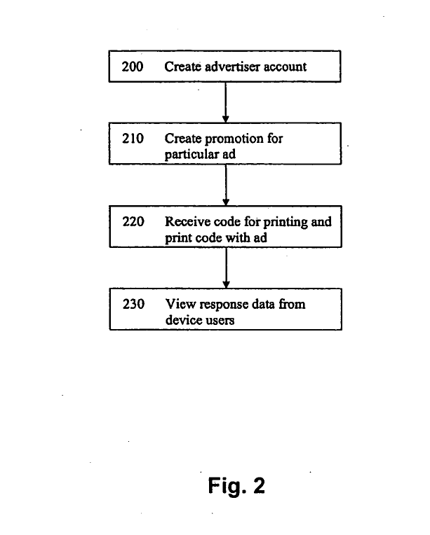

FIG. 2 shows a flow chart for a preferred embodiment for an advertiser 31, for example, retailer 150, shop 152 or hardware store 154, to establish a loyalty points program for scannable print advertisements 32. A potential advertiser can log onto a central website, for example called www.mygossspot.com, by creating a user name and password in a first step 200. The user name thus identifies the loyalty point program. At step 210, the advertiser 31 can create a promotion for a particular print advertisement 32, for example offering 10 loyalty points in its loyalty point program and entering an identification for the advertisement 32, for example NEWSDAY Sep. 10, 2006 VERSION 1. Advantageously, the web page for creating the promotion may provide for a tiered promotion, for example offering 10 loyalty points if a reader scans the advertisement and sends the scanned data in to server 60 with a device ID, 20 points if the reader scans the advertisement and sends the scanned data in to the server 60 with a device ID and an e-mail address, and 30 points if the reader scans the advertisement and sends in the scanned data to the server 60 with the device ID, an e-mail address and an answer to a survey question.

Each device 40 may for example have a software client, which, when the advertising data 34 is scanned, queries the customer 44 if they would like to send in the data to receive the promotion, and can have a preset number of options, such as send in the data with device ID, with device ID and e-mail, or with device ID, e-mail and a query response. This software client can be downloaded from the server 60 to device 40. The loyalty points accounts for individuals in the various programs 50, 52, 54 can be created each time data is sent in, so that for example when a customer 44 scans an ad from retailer 50 and send in the scanned data 34, the server 60 checks to see if the user ID matches any existing accounts in the loyalty points program 50, and if not, creates a new account based on the device ID. The accounts could be created separately also, for example, upon download of the software client by a customer 44.

In a step 220, the advertiser 31 can enter in and receive for example a 2-D barcode 34 for the particular NEWSDAY advertisement 32 and the promotion. This barcode 34 image is then added for example in the pre-press process to a printing plate containing the advertisement 32.

At a step 230, the advertiser 150 then can view on a web-page data corresponding to the advertisement 32 and other advertisements. For example, the advertiser 150 can know that 700 NEWSDAY VERSION 1 advertisements were scanned, and that 6000 NEWSDAY VERSION 2 advertisements were scanned. The data can be arranged by date, device IDs, etc. If information on the users of the devices are stored or provided, zip code, demographic or income information for example can be associated and analyzed as well. In addition, at a point of sale the advertisers 150, 152, 154 can track actual redemption of the promotions at the individual loyalty account level. The advertising effectiveness on sales, and not just on reading and scanning of the advertisements, can be tracked.

In addition, at step 210, different promotions could be created for the same advertisement, and thus the promotion effectiveness could be optimized. For example for the NEWSDAY VERSION 1 advertisement, two codes 34 for two different promotions could be generated, one of which offers 10 points, and one of which offers 20 points. The advertiser then can track if the promotion amount increases response rates, and by how much, to optimize promotions.

What is claimed is:

1. A method for providing individual loyalty point programs for a plurality of print advertisers comprising:
providing to a first print advertiser first advertising data to be printed with a first advertisement, the first advertising data identifying the first advertisement, the first advertising data capable of being scanned by a handheld device of a potential customer;
providing to a second print advertiser second advertising data to be printed with a second advertisement, the second advertising data identifying the second advertisement, the second advertising data capable of being scanned by the handheld device of the potential customer;
providing the potential customer with a first incentive to scan the first advertising data and a second incentive to scan the second advertising data; and
receiving the first or second advertising data scanned by the potential customer at a central server and as a consequence crediting a first or second loyalty point program, respectively, of the potential customer, the first loyalty point program providing loyalty points redeemable at the first print advertiser and the second loyalty point program being redeemable at the second print advertiser.

2. The method as recited in claim 1 further comprising providing the first print advertiser with the first advertising data and providing the second print advertiser with the second advertising data via the central server.

3. The method as recited in claim 2 further comprising providing the first print advertiser a website permitting the first print advertiser to define the first incentive.

4. The method as recited in claim 1 wherein the first incentive is tiered as a function of customer data the potential customer is willing to provide.

5. The method as recited in claim 4 wherein the customer data includes an e-mail address or an answer to a survey question.

6. The method as recited in claim 1 further comprising permitting the customer to download a software client, the software client querying the customer upon a scan of the first or second advertising data.

7. A system for providing a centralized plurality of loyalty point programs comprising:
a loyalty point collection server receiving information related to scanned advertising data of a plurality of print advertisers, the loyalty point collection server storing information on a plurality of loyalty point programs for the plurality of print advertisers, and crediting loyalty points to the respective loyalty point programs for individual users of handheld devices as a function of the scanned advertising data.

8. A method for providing individual loyalty point programs for a plurality of print advertisers comprising:
printing first advertising data with a first advertisement by a first print advertiser, the first advertising data identifying the first advertisement, the first advertising data capable of being scanned by a handheld device of a potential customer;
printing second advertising data with a second advertisement by a second print advertiser, the second advertising data identifying the second advertisement, the second advertising data capable of being scanned by the handheld device of the potential customer;
providing the potential customer with a first incentive to scan the first advertising data and a second incentive to scan the second advertising data; and
receiving the first or second advertising data scanned by the potential customer at a central server and as a consequence crediting a first or second loyalty point program, respectively, of the potential customer, the first loyalty point program providing loyalty points redeemable at the first print advertiser and the second loyalty point program being redeemable at the second print advertiser.
